(19) United States
(12) Patent Application Publication
(10) Pub. No.: US 2023/0128626 A1
(43) Pub. Date: Apr. 27, 2023

(54) MOBILE SOLAR ARRAY

(71) Applicant: WestGen Power Solutions, Inc., Santa Monica, CA (US)

(72) Inventors: Gregory Bilson, Santa Monica, CA (US); Alexander Nadolishny, Santa Monica, CA (US); Michael Claycomb, Santa Monica, CA (US)

(21) Appl. No.: 17/969,813

(22) Filed: Oct. 20, 2022

Related U.S. Application Data
(60) Provisional application No. 63/358,955, filed on Jul. 7, 2022.
(60) Provisional application No. 63/270,323, filed on Oct. 21, 2021.

(51) Int. Cl. H02S 20/32; H02S 30/10; H02S 30/20; H02S 40/38

(52) U.S. Cl. CPC H02S 20/32; H02S 30/10; H02S 30/20; H02S 40/38

(57) ABSTRACT

A solar array assembly that includes a chassis, a top solar array assembly, a right side solar array assembly pivotable with respect to the chassis along a first horizontal axis, and a left side solar array assembly pivotable with respect to the chassis along a second horizontal axis. The right side solar array assembly includes a right central solar array assembly, a first right end solar array assembly pivotably connected to the right central solar array assembly about a first vertical axis, and a second right end solar array assembly pivotably connected to the right central solar array assembly about a second vertical axis. The left side solar array assembly includes a left central solar array assembly, a first left end solar array assembly pivotably connected to the right central solar array assembly about a third vertical axis, and a second left end solar array assembly pivotably connected to the right central solar array assembly about a fourth vertical axis.

### CROSS-REFERENCE TO RELATED APPLICATIONS

This application claims the benefit of U.S. Provisional Application No. 63/358,955, filed on Jul. 7, 2022, and U.S. Provisional Application No. 63/270,323, filed on Oct. 21, 2021, the entireties of which are incorporated by reference herein.

### FIELD OF THE INVENTION

The present invention relates to a mobile solar array, and more particularly to a molar solar array that includes a plurality of foldable array assemblies or sections.

### BACKGROUND OF THE INVENTION

Mobile equipment has been in use for well over a century, including but not limited to such commonplace electrical items as generators, compressors, light towers, pumps and water purification units, communication and security systems. Traditionally powered by an internal combustion engine, this equipment is currently undergoing a transition to renewable or stored power sources (e.g., solar photovoltaic, wind, batteries), combinations of those or hybrid power systems combining a renewable energy source with battery energy storage and either an internal combustion engine or a natural gas/hydrogen fuel cell. A key element for a large portion of this new equipment is solar photovoltaic (PV) panels. PV power generation requires considerable surface area, which makes fixed PV arrays impractical for mobile applications due to the resulting size of the array. Many types of folding, sliding, tilting configurations have been developed to address this challenge. However, the majority of the proposed and implemented designs suffer from either limited overall surface area in the unfolded position, or high complexity in operation and high cost. Additionally, most configurations do not permit transporting the equipment with a large folded array inside of a standard ISO shipping container. This results in high shipping costs and high risk of damage to the equipment in transport.

Another issue with mobile solar arrays is that they are often deployed in hurricane prone regions, such as Caribbean islands. Therefore, it would be advantageous to be able to fold the components of the system into a configuration where the PV panels and cells are protected. The present invention addresses the issues discussed herein.

The background description disclosed anywhere in this patent application includes information that may be useful in understanding the present invention. It is not an admission that any of the information provided herein is prior art or relevant to the presently claimed invention, or that any publication specifically or implicitly referenced is prior art.

### SUMMARY OF THE PREFERRED EMBODIMENTS

In accordance with a first aspect of the present invention there is provided a solar array assembly that includes a chassis having a bottom, front and rear side surfaces, left and right side surfaces and a top, a horizontally oriented top solar array assembly associated with the top of the chassis, a right side solar array assembly and a left side solar array assembly. The right side solar array assembly is pivotable with respect to the chassis along a first horizontal axis between a storage position and a deployed position. The right side solar array assembly includes a right central solar array assembly having first and second ends. A first right end solar array assembly is pivotably connected to the first end of the right central solar array assembly about a first vertical axis. The first right end solar array assembly is pivotable between a storage position and a deployed position. The second right end solar array assembly is pivotably connected to the second end of the right central solar array assembly about a second vertical axis. The second right end solar array assembly is pivotable between a storage position and a deployed position.

The left side solar array assembly is pivotable with respect to the chassis along a second horizontal axis between a storage position and a plurality of deployed positions. The left side solar array assembly includes a left central solar array assembly having first and second ends. A first left end solar array assembly is pivotably connected to the first end of the left central solar array section about a third vertical axis. The first left end solar array assembly is pivotable between a storage position and a deployed position. The second left end solar array assembly is pivotably connected to the second end of the left central solar array section about a fourth vertical axis. The second left end solar array assembly is pivotable between a storage position and a deployed position.

The present invention is a foldable, electrically, mechanically or hydraulically actuated solar photovoltaic array for use in mobile power applications such as solar PV/battery energy storage systems or a hybrid energy generation systems that accept PV input. In a preferred embodiment, the invention provides a way of folding a large array of PV panels for safe and efficient transport and allows for fast and simple deployment for use. In a preferred embodiment, the design allows for a minimum of 20% of the array of PV modules to be exposed to light during storage and transport. If bi-facial PV modules (i.e., PV cells on both sides) are utilized, up to 60% of the PV arrays can be exposed to light during storage and transport. This exposure during transport enables battery system maintenance and partial recharging during storage or transport.

In a preferred embodiment, the mobile solar array assembly includes three main sections; a fixed central or top array section, two hinged side sections that tilt along a horizontal axis and four swing-out sections that pivot or tilt about a vertical axis.

The two hinged side sections tilt along a horizontal axis from the downward storage/transport position to an angle optimal for maximizing PV production (a deployed position). The tilting or pivoting can be performed by mechanical, electrical, hydraulic or pneumatic actuators and can be manual, automatic, movable via actuator or a combination of all. The actuators may be positioned horizontally under the central solar array or vertically between the hinged side sections and the body of the mobile power unit chassis. There may be one, two or more actuators per hinged side section. The vertically mounted actuators may be recessed into openings between PV modules mounted on the hinged side sections as to further reduce the overall width of the unit in the folded for transport configuration. In the folded transport position these sections can be secured by latches attached to the power unit chassis.

The four swing-out or end sections rotate away from the storage/transport position facing the two hinged side sections to the deployed position on the same plane as the hinged side sections. The swing-out sections can be moved manually or mechanically and secured in either position by a set of locks or other securing mechanism.

It will be appreciated that the array is integrated in the design of the mobile power unit chassis in a novel way that allows safely fitting the folded system into a high-cube International Organization for Standardization (ISO) shipping container. It will be appreciated that there are many ISO standard shipping containers. For example, 2 units or arrays may fit into a 40′ (or larger) high-cube ISO container, 1 unit may fit in a 20′ (or larger) ISO container. This is facilitated by the compact form factor of the equipment in the folded state as well as by a unique system of built-in guides that help protect the equipment during loading and unloading. The guides extend outwardly or upwardly far enough that they extend horizontally outside of the footprint of the mobile solar array unit (or vertically above the upper surface of the top portion so that parts or components that may be damaged do not contact the inside of the container walls or ceiling of the container or the loading door frame, and thereby possibly damaging any of the equipment on the mobile solar array (e.g., the side assemblies or top array portion).

In a preferred embodiment, the array described herein can be equipped with programmable automatic tilt actuator(s), directional light sensor(s) and a microprocessor. This configuration allows the use of the array as a single axis solar tracking system, further increasing the energy generation yield of the photovoltaic array. This system may allow the PV arrays to move with or follow the sun, to thereby maximize efficiency.

In a preferred embodiment, the present invention includes a software package providing operator guidance for optimal installation of the mobile solar array based on analysis of geographic latitude, current season, time of day and physical orientation of the array. The software, and instructions provided thereby, allows for a fast, correct and efficient installation of the equipment requiring only basic skills. The software also ensures correct installation of the equipment at night, in inclement weather or in the absence of the required geographic information.

In a preferred embodiment, the present invention includes at least two batteries or power units for storing the energy of the system. However, a single battery or power unit is also within the scope of the invention. Two or more batteries provides the ability to swap out one or more of the batteries while the other(s) continue to store power, thus providing uninterrupted service during the battery swap. Therefore, the system can be serviced while in use. It should be appreciated that the system can include any number of batteries or energy storage members, packaged into trays of several batteries, or not. Therefore, the “hot-swappable” configuration is possible with a minimum of two batteries.

In a preferred embodiment, the guide system for loading the mobile solar array system into a container for transport includes telescoping or otherwise movable guides, feet and/or arms that telescope, pivot or move vertically, horizontally or in another direction or include some type of adjustable positioning to extend beyond the outer perimeter of the wheels, walls, solar arrays or other components of the unit to protect them from the walls of the container when being loaded into the container and during transport. For example, the guides, feet and/or arms may include both vertically extending feet and horizontal arms. The protection system can also include bumpers that help guide the shipping container and protect during transport.

In a preferred embodiment, the solar arrays, including, e.g., the top array section or portion, hinged side assemblies, side solar array sections, swing-out sections, etc. are movable between a deployed configuration and a protected, stowed or storage configuration where the different sections are folded or moved into a configuration to protect from flying debris, high winds and other issues presented by inclement weather, for example in hurricane prone regions. The movement between the deployed configuration and the protected configuration can be automated (e.g., remote controlled) or manual.

In a preferred embodiment, the system includes a hingeable or pivotable or removable trailer tongue assembly (preferably A-frame shaped, but this is non-limiting). In a preferred embodiment the tongue is pivotable vertically or upwardly. However, this is not a limitation on the present invention. The tongue assembly may also be fully removable for security purposes and so that the trailer cannot be stolen.

In a preferred embodiment, the system may include film or a cover over various portions of the unit, such as the solar arrays, to help with concealment of the mobile solar array system and trailer. For example, films or sheet applications that include specific camouflage or camo patterns intended for solar arrays can be used.

The array assembly may include a chassis, a horizontally oriented fixed top array portion associated with the top of the chassis, and first and second side assemblies associated with opposite sides of the chassis. The first and second side assemblies are pivotable along a horizontal axis between a storage position and a plurality of deployed positions. The first and second side assemblies may each include a side solar array section having first and second ends. The first and second end sections may be pivotably connected to the first and second ends of the side solar array sections.

In the storage position, the first and second side assemblies may include a frame, mesh or other protective layer or panel on an outer surface, so that the solar arrays are protected from debris. The first and second side assemblies may be pivotable between the storage position and the plurality of deployed positions automatically. The array assembly may include programmable automatic tilt actuators, one or more directional light sensors and a microprocessor. The array can be used as a single axis solar tracking system, thereby further increasing energy generation yield of the photovoltaic array.

The array assembly may be is sized to be received in a standard ISO shipping container. The array assembly may include at least one side loading guide arm that is movable outwardly and/or horizontally from a stowed position to a deployed position. The array assembly may include at least one bottom loading guide arm or jack that is movable downwardly and/or vertically from a stowed position to a deployed position.

The array assembly may include first and second batteries and a method of using the array assembly may include routing energy to the first battery, switching energy to being routed to the second battery, removing the first battery while continuing to route power to the second battery, servicing the first battery, and reinstalling the first battery.

The solar array assembly may include a tongue assembly that is pivotable between a stowed position and a deployed position. The tongue assembly may be removable from the chassis. One or more of the at least one PV panels may include a PV film and/or sheet member thereon that includes a camouflage pattern. The mobile solar array system chassis or main body portion houses the internal components, such as the energy storage systems or batteries, the controller, communication, security, water purification, and, in the case of hybrid equipment, the auxiliary power generation equipment. Latches, locks or the like can be used to maintain the side assemblies in position during transport. Wheels can be included to provide mobility to the solar array assembly.

The invention, together with additional features and advantages thereof, may be best understood by reference to the following description.

### BRIEF DESCRIPTION OF THE DRAWINGS

The invention may be more readily understood by referring to the accompanying drawings in which:

FIG. 1 is a perspective view of a solar array assembly with the side solar array assemblies in a deployed position in accordance with a preferred embodiment of the present invention;

FIG. 2 is a perspective view of the solar array assembly with the side solar array assemblies in the storage position;

FIG. 3 is an front elevational view of the solar array assembly with the side solar array assemblies in a deployed position;

FIG. 4 is a right side perspective view of the solar array assembly;

FIG. 5 is a left side perspective view of the solar array assembly;

FIG. 6 is a top plan view of the solar array assembly in the storage or transport position;

FIG. 7 is a perspective view of a portion of the solar array assembly with the second end solar array assembly in the deployed position;

FIG. 8 is a perspective view of a portion of the solar array assembly with the end solar array assemblies in the storage position; and

FIG. 9 is a perspective view the solar array assembly right side solar array assembly in the deployed position to show some of the interior components.

Like numerals refer to like parts throughout the several views of the drawings.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments. If a component is not shown in a drawing then this provides support for a negative limitation in the claims stating that that component is “not” present. However, the above statement is not limiting and in another embodiment, the missing component can be included in a claimed embodiment.

Reference in this specification to “one embodiment,” “an embodiment,” “a preferred embodiment” or any other phrase mentioning the word “embodiment” means that a particular feature, structure, or characteristic described in connection with the embodiment is included in at least one embodiment of the-disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional. Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

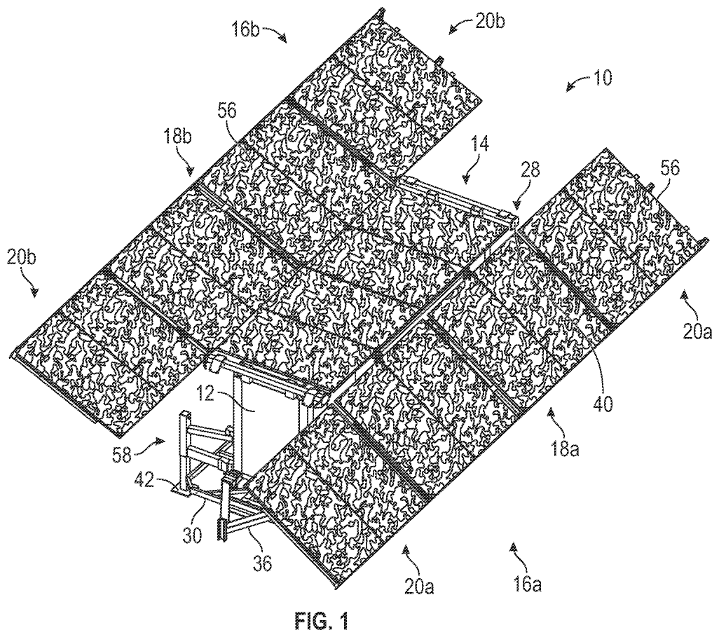

FIGS. 1-9 show a solar array assembly 10 in accordance with a preferred embodiment of the present invention. Generally, the solar array assembly 10 includes a chassis 12 that includes a bottom 12a, front and rear side surfaces 12b and 12c, left and right side surfaces 12d and 12e and a top 12f, a horizontally oriented top solar array assembly 14 associated with the top of the chassis 12, a right side solar array assembly 16a and a left side solar array assembly 16b. The right side solar array assembly 16a is pivotable with respect to the chassis 12 along a first horizontal axis A1 between a storage position and a plurality of deployed positions. The right side solar array assembly 16a includes a right central solar array assembly 18a having first and second ends. A first right end solar array assembly 20a is pivotably connected to the first end of the right central solar array assembly 18 about a first vertical axis A2. The first right end solar array assembly 20a is pivotable between a storage position and a deployed position. The second right end solar array assembly 20a is pivotably connected to the second end of the right central solar array assembly 18a about a second vertical axis A3. The second right end solar array assembly 20a is pivotable between a storage position and a deployed position.

The left side solar array assembly 16b is pivotable with respect to the chassis 12 along a second horizontal axis A4 between a storage position and a plurality of deployed positions. The left side solar array assembly 16b includes a left central solar array assembly 18b having first and second ends. A first left end solar array assembly 20b is pivotably connected to the first end of the left central solar array section 18b about a third vertical axis A5. The first left end solar array assembly 20b is pivotable between a storage position and a deployed position. The second left end solar array assembly 20b is pivotably connected to the second end of the left central solar array section 18b about a fourth vertical axis A6. The second left end solar array assembly 20b is pivotable between a storage position and a deployed position.

FIG. 1 shows the solar array assembly 10 and main body portion or chassis 12 with the various solar array portions or sections in the deployed position. In a preferred embodiment, these sections include the top solar array assembly 14 or top array section and left and right side solar array assemblies 16a and 16b. It will be appreciated that the terms “left” and “right” are based on a viewer facing the front of the solar array assembly 10 and are not intended to be limiting. In FIG. 1, the left and right side solar array assemblies 16a and 16b are angled to face the sun. It will be appreciated that the deployed position is not a single position, but any position where the side assemblies have been moved from the storage position such that they can receive solar energy from the sun in operation.

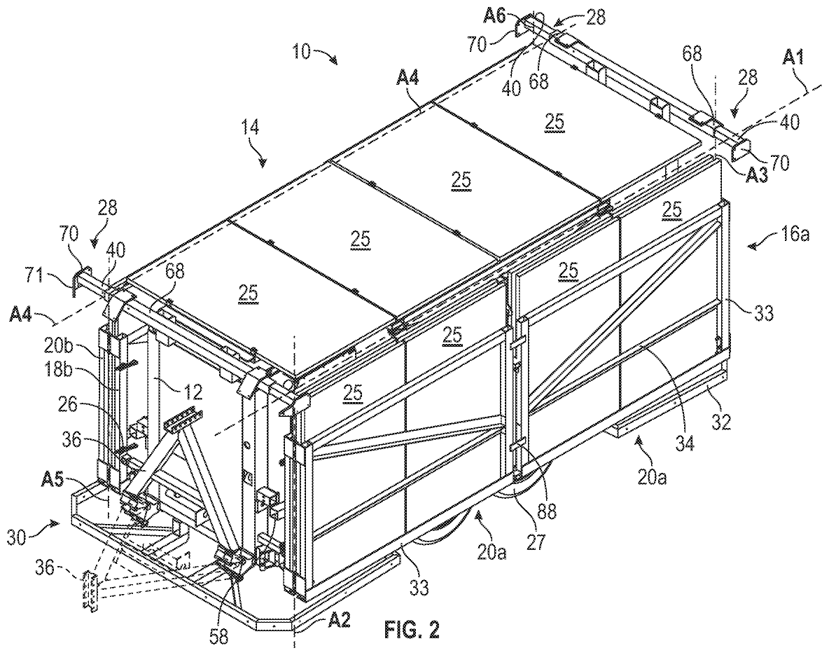

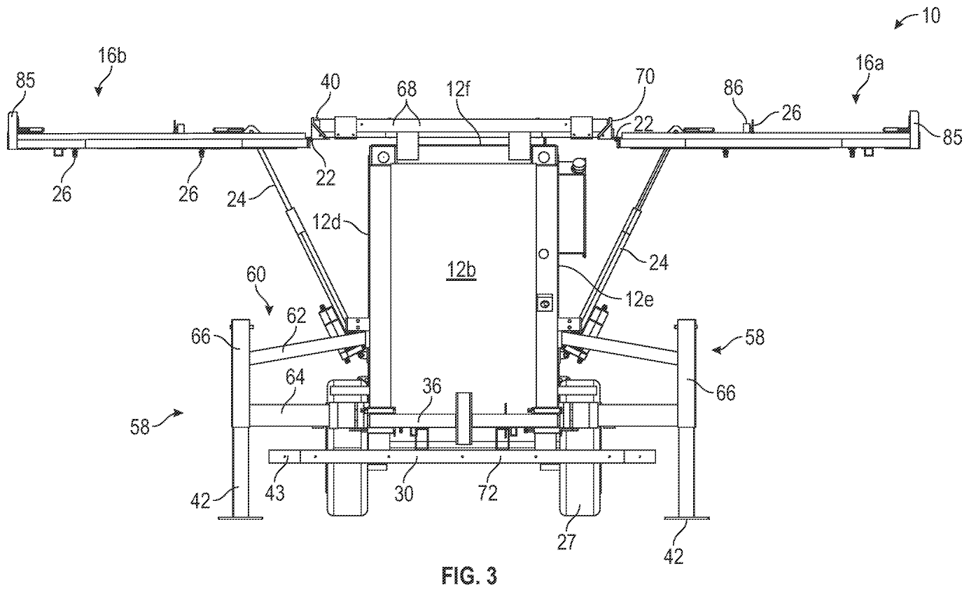

With reference to FIGS. 2-3, the left and right side solar array assemblies 16a and 16b preferably each include left and right central solar array assemblies 18a and 18b and swing-out sections or first and second end solar array assemblies. In a preferred embodiment, the top solar array assembly 14 is fixed. However, this is not a limitation and in other embodiments, the top array portion can be movable, pivotable or slidable, etc. The side solar array assemblies 16 are each pivotable along a horizontal axis between a storage position (see FIG. 2) and a plurality of deployed positions (see FIGS. 1 and 3 for two examples). The vertical or first axis A1 for the front right side solar array assembly 16a is labeled in FIG. 2. All four vertical axes are referred to as first axis A1 herein. Hinges 22 can be utilized for the pivotability between all the different sections. For example, see hinges 22 between the top solar array assembly 14 and the left and right side solar array assemblies 16a and 16b (and specifically the left and right central solar array assemblies 18a and 18b) in FIG. 3. It will be appreciated that the side solar array assemblies 16a and 16b can be pivotable manually or automatically. For example, see the extendable arms or power tilt actuators 24 shown in FIG. 3, which are used to pivot the left and right side solar array assemblies 16a and 16b about the horizontal axes A1 and A4. The actuators 24 can be mounted horizontally under the central solar array assemblies. In other embodiments the actuators can be mounted vertically or at an angle between the side solar array assemblies and the chassis 12.

In a preferred embodiment, the first and second end solar array assemblies are pivotably or hingedly connected to the opposite ends (or front and rear ends) of the left and right central solar array assemblies 18a and 18b and are pivotable on vertical hinges 22 or along the vertical axes A2, A3, A5 and A6 (when the side solar array assemblies 16a and 16b are in the storage position) between a storage position and a deployed position. As shown in FIG. 3, when fully deployed, the first and second right and left end solar array assemblies 20a and 20b extend generally parallel to (or co-planar with) the left and right central solar array assemblies 18a and 18b. The end solar array assemblies can be pivotable manually or using tilt actuators or other mechanical and/or automated actuators. In the embodiment shown in the figures, the end solar array assemblies are pivoted manually about the horizontal axes and then the side solar array assemblies are pivoted about the horizontal axes via arms 24 and the actuators associated therewith.

In a preferred embodiment, each of the array assemblies (e.g., top solar array assembly 14, left and right central solar array assemblies 18a and 18b and first and second left and right end solar array assemblies 20a and 20b) include a frame 33 (comprising a plurality of frame members 34) and one or more solar arrays or solar portions 25. The solar portions 25 include PV cells, which are known in the art and will not be described herein in detail. The solar portions 25 are secured to the frame 33. As shown in FIG. 2 (referring to the right side solar array assembly 16a, in the deployed position, the frames 33 of the first and second right end solar array assemblies 20a face outwardly and protect the solar portions 25. The first and second right end solar array assemblies 20a overlap the right central solar array assembly 18a, such that the right central solar array assembly 18a is positioned between the first and second right end solar array assemblies 20a and the chassis 12. The first and second right end solar array assemblies 20a (or any other section of the solar array) can include other protection members or layers. For example, a mesh layer can be included over the solar portion 25 or frame 33 for added protection. The protection layers, panels or sheets can be located on either side of the solar panels (exterior or interior). A frame or other protection layer can also be movable over or with the top solar array assembly 14. In another embodiment, the side solar array assemblies and/or end solar array assemblies can include PV cells or solar portions on both sides thereof or the solar portions themselves can include PV modules on both sides or faces. This can include bi-facial PV modules or solar portions on opposite sides of the frame.

Generally, as shown in the figures, the left and right side solar array assemblies 16a and 16b are associated with opposite sides of the chassis or main body portion and are pivotable or hingeable along a horizontal axis between a storage or stowage position and a plurality of deployed positions (both horizontal axes are referred to herein as second axis A2 and one of them is labeled in FIG. 2). The left and right central solar array assemblies 18a and 18b are the central or middle portions of the left and right side solar array assemblies 16a and 16b and include the first and second right and left end solar array assemblies 20a and 20b that are pivotably connected to the first and second ends of the left and right central solar array assemblies 18a and 18b. The first and second end solar array assemblies are pivotable along the vertical axes, which are generally perpendicular to the horizontal axes along which the left and right central solar array assemblies 18a and 18b pivot. As shown in FIG. 3, in a preferred embodiment, the left and right side solar array assemblies 16a and 16b (and the left and right central solar array assembly 18a and 18b) are pivotably connected to the top solar array assembly 14. However, the left and right side solar array assemblies 16a and 16b can also be pivotably connected to the chassis 12 or any component thereof or connected thereto.

Therefore, with reference to the left side solar array assembly 16b in FIG. 1, to get to the stowed position from the deployed position, the entire left side solar array assembly 16b pivots downwardly to a vertical orientation. Then, the first and second left end solar array assemblies 20b are pivoted inwardly about 180° (+/−5° due to possible “play” in the joint or hinges, etc.) until they overlap the two solar portions 25 or panels of the left central solar array assembly 18b. It will be appreciated that this process or method does not have to occur in these exact steps or order. The left end solar array assemblies 20b are latched or secured in place. This is described further below.

In another order, to get to the stowed position from the deployed position, the first and second left end solar array assemblies 20b pivot inwardly about 180° (+/−5° due to possible “play” in the joint or hinges, etc.) until they overly the two solar portions 25 or panels of the left central solar array assembly 18b. The entire left side solar array assembly 16b then pivots downwardly to the storage position where the folded left side solar array assembly 16b is generally or about vertical, as shown in FIG. 2. The first and second left solar array assemblies 20 can pivot while the left central solar array assembly 18b pivots toward the stowed position or the left central solar array assembly 18b and entire left side solar array assembly 16b can pivot downwardly and then the left end solar array assemblies 20b can pivot inwardly to the storage position. Latches, locks or the like can be used to maintain the components of the side solar array assemblies in position during transport. Wheels 27, which are connected to the chassis 12, can be included to provide mobility to the solar array assembly 10.

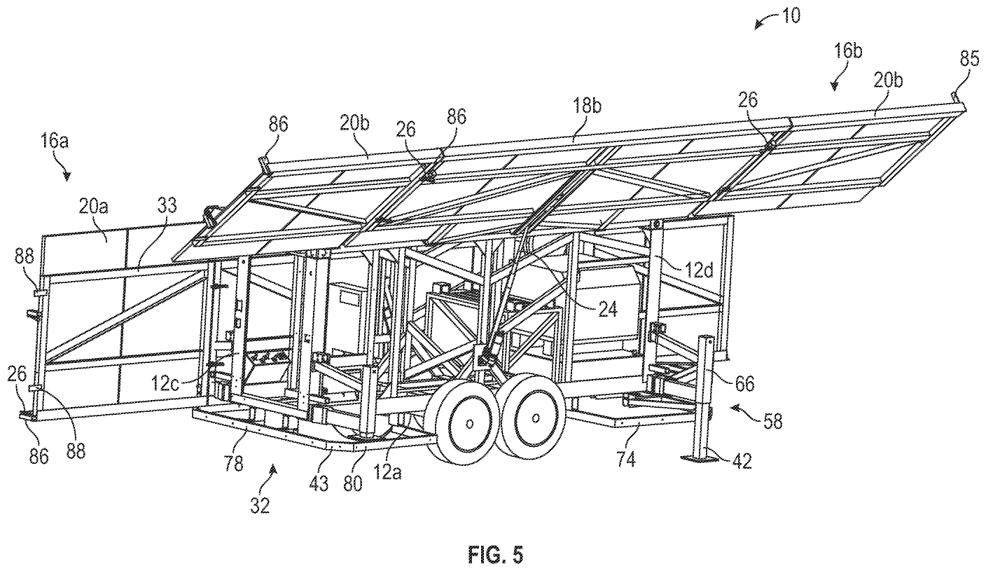

In a preferred embodiment, the solar array assembly 10 includes jack assemblies 58 to maintain the solar array assembly 10 in a stable position during both transport and deployment in the field. A single jack assembly 58 will be described. Preferably, the jack assembly 58 includes a frame portion 60 and a foot 42. The frame portion 60 includes upper and lower arms 62 and 64 that are connected to the chassis 12 and a receptacle member 66 that receives the foot 42 therein. The foot 42 is movable vertically between a stowed position and a deployed position. In the deployed position, the bottom surface of the foot 42 is positioned below the wheels 27, as shown in FIG. 3. FIG. 5 shows one of the feet 42 in the deployed position and the other in the stowed position. Any method for securing the foot 42 in either of the stowed or deployed position is within the scope of the present invention. In an exemplary embodiment, the foot 42 includes an outwardly protruding spring biased member or ball that is biased into one or more openings in the receptacle member 66 to secure the contact arm the desired position.

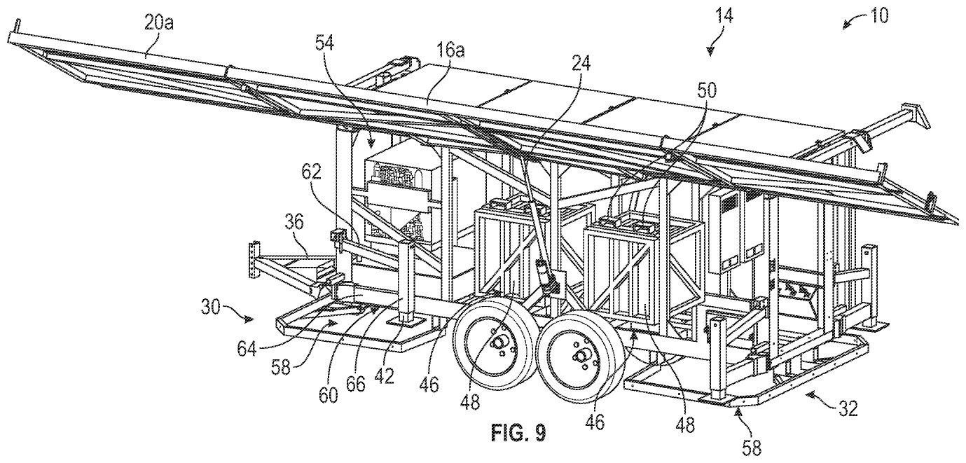

In a preferred embodiment, the jack assembly 58 is pivotable about a vertical axis between a stowed position and a deployed position. In this embodiment, the upper and lower arms 62 and 64 are pivotably connected to the chassis 12. FIG. 9 shows the front right jack assembly 58 in the stowed position and the rear jack assembly 58 in the deployed position (note the feet 42 are both in the stowed position). In the stowed position, the jack assemblies 58 are positioned between the side solar array assembly (in the storage position) and the chassis 12, as shown in FIG. 2.

As discussed herein, in a preferred embodiment, the solar array assembly 10 is sized to fit in a standard ISO shipping container when folded or in the storage position for transport. Therefore, as shown in FIG. 2, the solar array assembly 10 may include left and right side arm assemblies 28 and/or a front bumper 30 and/or a rear bumper 32. The left and right side arm assemblies 28 and front and rear bumpers 32, help with loading and unloading of the solar array assembly 10 in the shipping container and help prevent damage to the components thereof during transport.

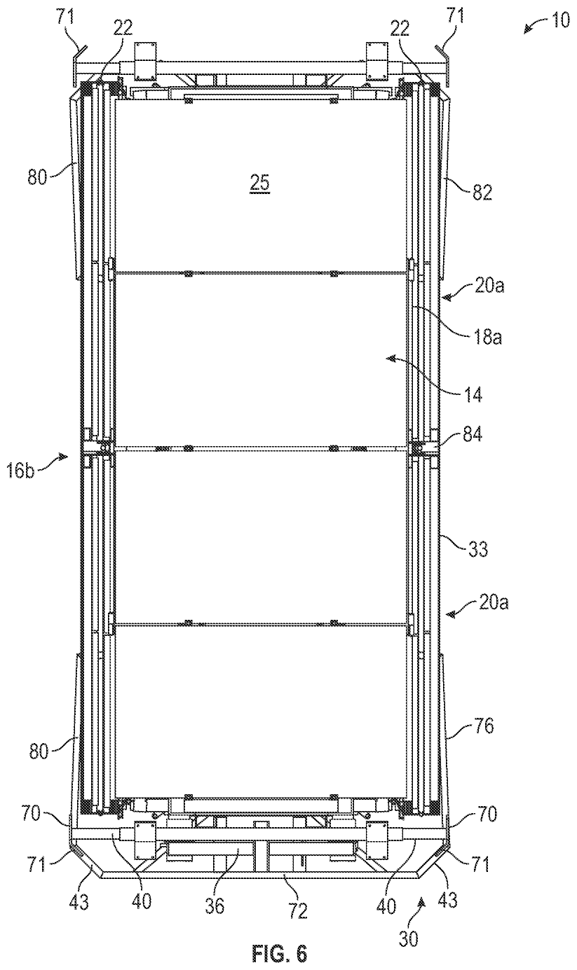

In a preferred embodiment, the left and right side arm assemblies 28 are configured to protect the left and right side solar array assemblies 16a and 16b when the side solar array assemblies are in the storage position. Each side arm assembly 28 includes a contact arm 40 that moves or telescopes inwardly and outwardly (generally horizontally) between a stowed position and an extended or deployed position. The contact arm 40 is received in a receptacle member 68 and includes a contact member 70 on a distal end thereof. Each of the four contact arms 40 can be associated with a separate receptacle member 68 or, as shown in FIG. 2, opposing contact arms 40 can be received in opposite ends of a single receptacle member 68. There can be more or less than four contact arms. FIG. 3 shows the contact arms 40 in the stowed position and FIGS. 2 and 6 in the deployed position. As shown in FIG. 6, the distal ends of the left and right contact arms 40 (and the contact members 70) extend horizontally outwardly far enough that they are positioned outwardly of the left and right side solar array assemblies 16a and 16b (and the components thereof, and, in particular, the outer surfaces of the first and second end solar array assemblies). In this position, the distal ends of the contact arms are positioned outboard of the left and right side solar array assemblies to contact the inside surface of a shipping container or other surface to protect the solar arrays and other components. In the stowed position, the contact arms are positioned inboard of the outer surfaces of the first and second end solar array assemblies. The contact members 70 can include an angled portion 71 to help guide the solar array assembly into a shipping container when being loaded therein. Any method for securing the contact arm 40 in either of the stowed or deployed position is within the scope of the present invention. In an exemplary embodiment, the contact arm 40 includes an outwardly protruding spring biased member or ball that is biased into one or more openings in the receptacle member 68 to secure the contact arm the desired position.

As shown in FIGS. 2 and 9, the front bumper 30 includes a front member 72, a left side member 74 and a right side member 76 and the rear bumper 32 includes a rear member 78, a left side member 80 and a right side member 82. The front and rear bumpers are secured or attached to the bottom 12a or underside of the chassis 12. The chassis 12 includes a front side surface 12b, a rear side surface 12c, a left side surface 12d and a right side surface 12e. The front and rear bumpers 30 and 32 can also include corner members 43.

With reference to FIG. 6, it will be appreciated that the left and right side solar array assemblies 16 (and, in particular, the outer surface of the frames 33) define left and right vertical planes. The left and right side members 74 and 76 of the front bumper 30 are positioned outwardly of the left and right vertical planes, respectively. The left and right side members 80 and 82 of the rear bumper 32 are positioned outwardly of the left and right vertical planes, respectively. Furthermore, as shown in FIGS. 6, the distal end of the contact arms 40 (and the contact members 70 thereon) are positioned outwardly of the left and right vertical planes. As shown in FIG. 6, the corner members 43 can extend parallel to the angled portion 71 of the contact arm 40 and the remainder of the contact member 70 can extend generally parallel to at least a portion of the left and right members of the front bumper 30 to provide common bumper surfaces. This is shown on the front of the solar assembly 10 and can also be included on the rear.

Therefore, the contact arms 40 are positioned, when in the deployed position, beyond or distal to the left and right horizontal planes vertical planes to a position where they prevent the other components of the solar array assembly 10 from contacting the side, walls and the feet 42, when in the deployed position, extend below or even with a horizontal plane defined by the bottom of the wheels 27 and against the floor of the container, ground or other structure.

As shown in FIG. 2, in a preferred embodiment, the solar array assembly 10 includes a hingeable or pivotable tongue assembly 36 that hinges between a stowed position (shown in solid lines) and a deployed position (shown in hidden lines). The tongue assembly 36 is pivotably connected to the chassis 12 preferably via hinges. In the stowed position, the tongue assembly 36 is positioned inwardly or inboard of the front member 72 of the front bumper 30, which may also be referred to herein as being positioned within the footprint of the front bumper 30 (both to the front and sides). Preferably, the tongue assembly 36 may also be fully removable for security purposes (e.g., so the trailer cannot be stolen).

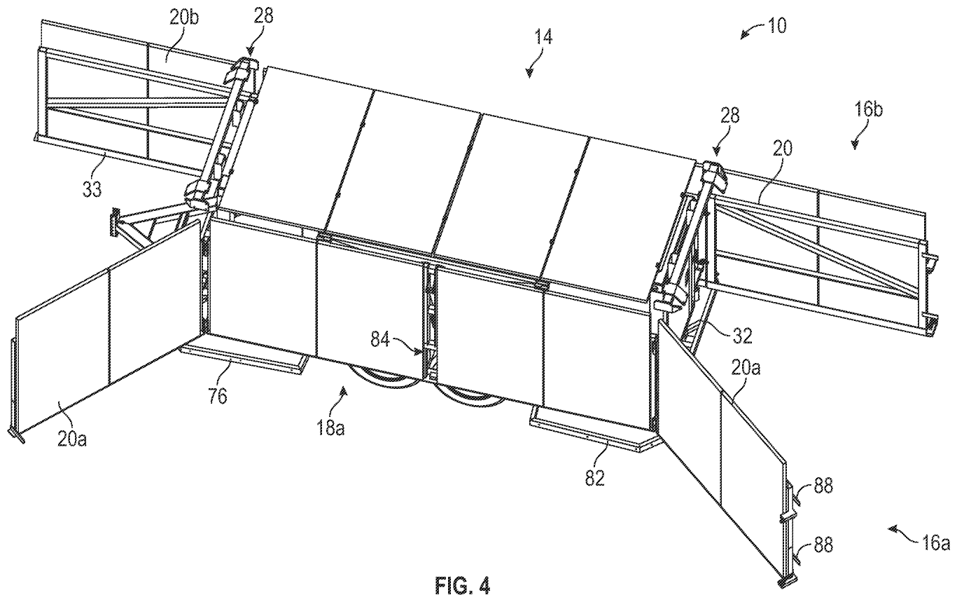

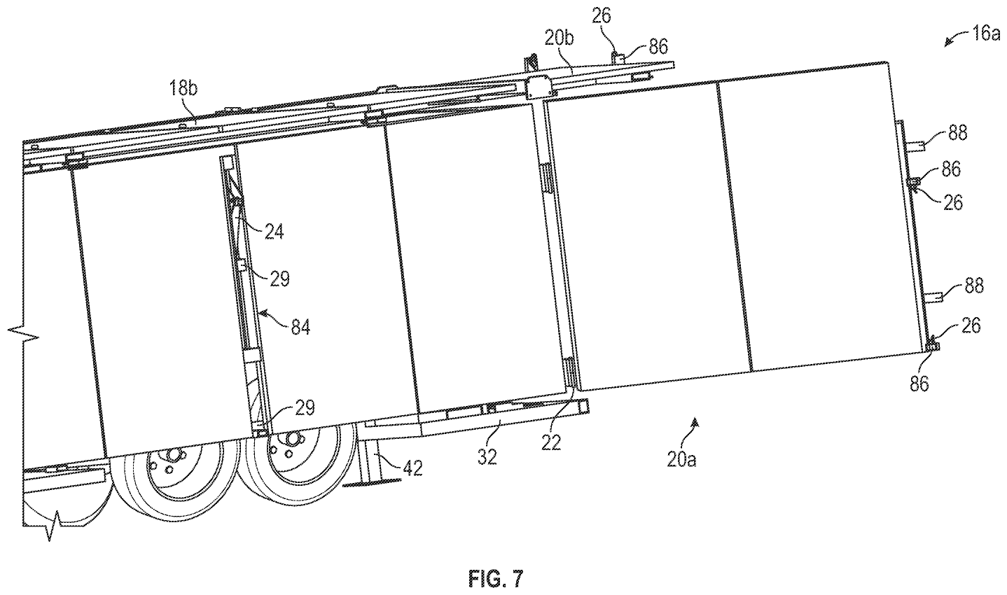

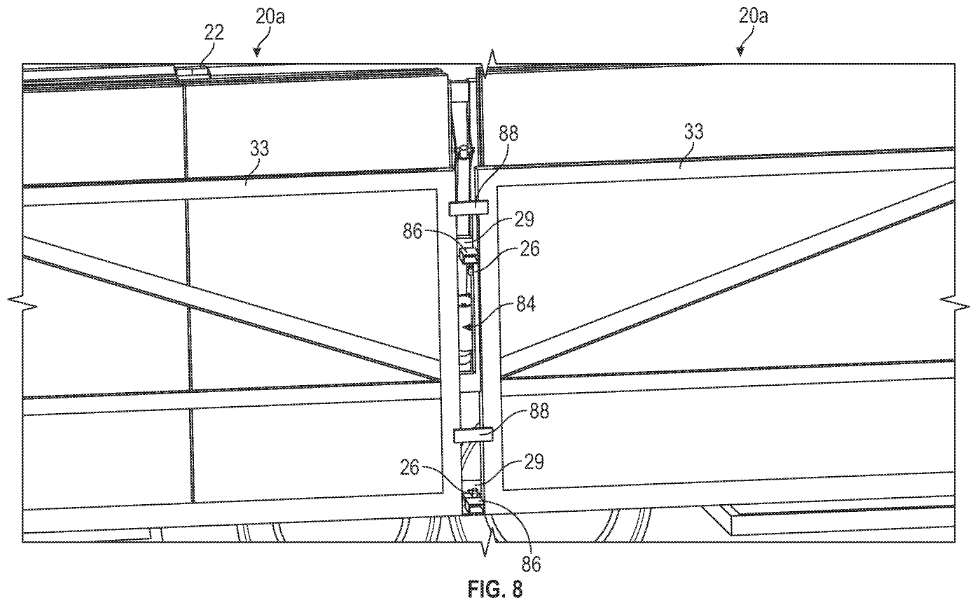

With reference to FIGS. 4, 7 and 8, the solar array assembly 10 includes latches or other components for securing the first and second end solar array assemblies in the storage position and/or for securing the first and second end solar array assemblies in the deployed position. In a preferred embodiment, the frame 33 of the second end solar array assembly includes one or more latches 26 thereon that mate with one or more plates or strikers 29 associated with the frame 33 of the central solar array assembly 18. As shown in FIG. 7 (which shows the right side solar array assembly 16a), the strikers 29 may be positioned in a gap 84 between two solar portions of the right central solar array assembly 18a. The latches 26 may be positioned on or secured to base members 86 that is secured to the frame 33. The latches 26 may be spring biased pivotable latches. The second right end solar array assembly 20a may include one or more stop members 88 extending therefrom that bridge the gap 84 and overlap and secure in place the first right end solar array assembly 20a when in the storage position, as shown in FIG. 8. The first right end solar array assembly 20a may include one or more extension members 85 (one is shown in the drawings) that is received in gap 84.

The unlatching or opening of the first and second end assemblies to move them from the storage to the deployed position will now be described. Latches 26 are unlatched from the strikers and the rear or second right end solar array assembly 20a is pivoted to the deployed position. Because the stop members 88 are no longer securing the front or first right end solar array assembly 20a, the first right end solar array assembly 20a can be pivoted to the deployed position. Hinges 22 connecting the frames 33 of the first and second right end solar array assemblies 20a to the opposite ends of the right central solar array assembly 18a allow the pivoting action. In a preferred embodiment, as shown in FIGS. 5, the left central solar array assembly 18b includes latches 26 that latch or lock the first and second left end solar array assemblies 20 in the deployed position. It will be appreciated that any components on the left side solar array assembly 16b may be included on the right side solar array assembly 16a and vice versa.

To move the first and second end solar array assemblies back to the storage position the following steps may occur. The latches 26 on the inner face of the left central solar array assembly 18b (shown in FIG. 5) are unlatched, thereby allowing the first and second left end solar array assemblies 20b to pivot. The front or first left end solar array assembly 20b is pivoted into place first so that the extension member 85 is received in gap 84 and then the rear or second left end solar array assembly 20b is pivoted into place where the latches 26 are received on and latched on strikers 29. The stop members 88 bridge the gap 84 to secure the first left end solar array assembly 20b in place. It will be appreciated that the positions of the latches and strikers and/or the stop members can be reversed. Furthermore, the latches can be included on the other of the end solar array assembly. Any type of reversal of components is within the scope of the present invention and appended claims. The latching mechanisms shown in the drawings and described herein are not limiting. Any type of latch, lock, securing member or the like for securing or holding the various array assemblies in the storage or deployed positions is within the scope of the present invention.

FIG. 9 shows the right side solar array assembly 16a in a deployed position to expose the chassis interior, which may include such components as the battery containers 46 with the batteries 48 therein. In a preferred embodiment, the batteries 48 include loops 50 on the top thereof that are configured to receive the forks of a forklift so that the battery 48 can be removed vertically from the battery container 46. As discussed herein, one of the purposes of including two batteries or power units is so the system can continuously be powered and so that the system can continuously store energy. For example, if the first battery needs service and/or is full, power can be routed to or from the second battery. The first battery can then be removed, used, serviced or the like and be replaced before the second battery needs servicing.

As shown in FIG. 9 and the other figures, the solar array assembly 10 or trailer may also include a central electronics system 54. The central electronics system 54 may include for example, central processing unit(s), microprocessor(s), computer(s), controller(s), server(s), software, communications (e.g., WiFi, wireless connectivity, cellular communication, etc.) and any other electronically related components, items or the like necessary for controlling and/or operating the system), actuators, hinges, wheels, axles, arms, array assemblies, etc. It will be appreciated that any of these components can be included separately or within the central electronics system 54.

As shown in FIG. 1, the system may include a sheet member or cover layer 56 to help with concealment of the solar array assembly 10 and trailer. For example, films or sheet applications or members that include specific camouflage or camo patterns intended for solar arrays or related to the area where the system is deployed can be used. In FIG. 1, the cover layers 56 have been applied to all of the various solar portions 25 (e.g., on the top solar array assembly 14 and side solar array assemblies 16).

In a preferred embodiment, the solar array assembly 10 includes programming, software or the like and the electrical and data communication necessary to allow the various array assemblies (e.g., the top solar array assembly 14, left and right side solar array assemblies 16a and 16b, left and right central solar array assemblies 18a and 18b and first and second left and right end solar array assemblies 20a and 20b) to be pivoted or moved to a desired position. This allows the use of the array as a single axis solar tracking system, further increasing energy generation yield of the photovoltaic arrays. It will be appreciated, that some of the array assemblies may also be movable manually between the stowed and deployed positions. In an embodiment, the first and second end solar array assemblies or movable between the stowed and deployed positions manually and then the left and right side solar array assemblies are movable via the tilt actuators 24. It will be appreciated that the solar arrays/panels and PV cells are in communication with the batteries for storing the power collected or received by the solar panels. It will also be appreciated that the components and systems for data and electrical communication between components within the system are not described herein in detail. However, a person of ordinary skill in the art would readily understand such components.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

Although the operations of any method(s) disclosed or described herein either explicitly or implicitly are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

The teachings of the disclosure provided herein can be applied to other systems, not necessarily the system described above. The elements and acts of the various embodiments described above can be combined to provide further embodiments. Any measurements or dimensions described or used herein are merely exemplary and not a limitation on the present invention. Other measurements or dimensions are within the scope of the invention.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will include the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A solar array assembly comprising:
a chassis that includes a top, bottom, left and right side surfaces, and front and rear surfaces,
a horizontally oriented top solar array assembly associated with the top of the chassis,
a right side solar array assembly pivotable with respect to the chassis along a first horizontal axis between a storage position and a deployed position, wherein the right side solar array assembly includes a right central solar array assembly having first and second ends, wherein a first right end solar array assembly is pivotably connected to the first end of the right central solar array assembly about a first vertical axis, wherein the first right end solar array assembly is pivotable between a storage position and a deployed position, wherein a second right end solar array assembly is pivotably connected to the second end of the right central solar array assembly about a second vertical axis, wherein the second right end solar array assembly is pivotable between a storage position and a deployed position,
a left side solar array assembly pivotable with respect to the chassis along a second horizontal axis between a storage position and a deployed position, wherein the left side solar array assembly includes a left central solar array assembly having first and second ends, wherein a first left end solar array assembly is pivotably connected to the first end of the left central solar array assembly about a third vertical axis, wherein the first left end solar array assembly is pivotable between a storage position and a deployed position, wherein a second left end solar array assembly is pivotably connected to the second end of the left central solar array assembly about a fourth vertical axis, wherein the second left end solar array assembly is pivotable between a storage position and a deployed position.

2. The solar array assembly of claim 1 wherein the first right end solar array includes a frame having a solar portion secured thereto and the second right end solar array includes a frame having a solar portion secured thereto, wherein in the storage position, the frame of the first right end solar array and the frame of the second right end solar array face outwardly, and wherein the first left end solar array includes a frame having a solar portion secured thereto and the second left end solar array includes a frame having a solar portion secured thereto, wherein in the storage position, the frame of the first left end solar array and the frame of the second left end solar array face outwardly.

3. The solar array assembly of claim 2 wherein in the storage position, the right central solar array assembly is positioned between the first and second right end solar array assemblies and the chassis, and wherein in the storage position, the left central solar array assembly is positioned between the first and second left end solar array assemblies and the chassis.

4. The solar array assembly of claim 1 wherein the top solar array assembly includes a frame and a solar portion, wherein the right central solar array assembly includes a frame and a solar portion, wherein the left central solar array assembly includes a frame and a solar portion, wherein the frame of the right central solar array assembly is pivotably connected to the frame of the top solar array assembly such that the right side solar array assembly can pivot about the first horizontal axis, and wherein the frame of the left central solar array assembly is pivotably connected to the frame of the top solar array assembly such that the left side solar array assembly can pivot about the second horizontal axis.

5. The solar array assembly of claim 1 further comprising a left arm side assembly that includes a left contact arm that is movable between a stowed position and a deployed position, wherein the first and second left end solar array assemblies have an outer surface, wherein when the first and second left end solar array assemblies are in the storage position and the left contact arm is in the deployed position, a distal end of the left contact arm is positioned horizontally outboard of the outer surfaces of the first and second left end solar array assemblies, and wherein when the first and second left end solar array assemblies are in the storage position and the left contact arm is in the stowed position, the distal end of the left contact arm is positioned horizontally inboard of the outer surfaces of the first and second left end solar array assemblies.

6. The solar array assembly of claim 1 further comprising at least a first jack assembly that includes a frame portion and a foot, wherein the jack assembly is hingedly connected to the chassis and is pivotable between a stowed position and a deployed position, wherein the chassis includes a plurality of wheels attached thereto, wherein the foot is movable vertically between a stowed position and a deployed position.

7. The solar array assembly of claim 1 wherein the first and second left end solar array assemblies are co-planar with the left central solar array assembly in the deployed position, and wherein the first and second right end solar array assemblies are co-planar with the right central solar array assembly in the deployed position.

8. The solar array assembly of claim 1 further comprising a controller, wherein when the right and left side solar array assemblies are in the deployed position, the controller is configured to pivot the right and left side solar array assemblies about the first and second axes, respectively, to follow the sun.

9. The solar array assembly of claim 1 further comprising a front bumper and a tongue assembly that is pivotable between a stowed position and a deployed position, wherein the front bumper has a forward surface, wherein in the deployed position at least a portion of the tongue assembly is positioned outboard of the forward surface, and wherein in the stowed position the tongue assembly is positioned inboard of the forward surface.

10. The solar array assembly of claim 1 wherein the top solar array assembly includes a cover layer thereon that includes a camouflage pattern.

11. A solar array assembly comprising:
a chassis that includes a top, bottom, left and right side surfaces, and front and rear surfaces,
a horizontally oriented top solar array assembly associated with the top of the chassis,
a right side solar array assembly pivotable with respect to the chassis along a first horizontal axis between a storage position and a deployed position, wherein the right side solar array assembly includes a right central solar array assembly having first and second ends, wherein a first right end solar array assembly is pivotably connected to the first end of the right central solar array assembly about a first vertical axis, wherein the first right end solar array assembly is pivotable between a storage position and a deployed position, wherein a second right end solar array assembly is pivotably connected to the second end of the right central solar array assembly about a second vertical axis, wherein the second right end solar array assembly is pivotable between a storage position and a deployed position, wherein the first right end solar array includes a frame having a solar portion secured thereto and the second right end solar array includes a frame having a solar portion secured thereto, wherein in the storage position, the frame of the first right end solar array and the frame of the second right end solar array face outwardly, wherein in the storage position, the right central solar array assembly is positioned between the first and second right end solar array assemblies and the chassis,
a left side solar array assembly pivotable with respect to the chassis along a second horizontal axis between a storage position and a deployed position, wherein the left side solar array assembly includes a left central solar array assembly having first and second ends, wherein a first left end solar array assembly is pivotably connected to the first end of the left central solar array assembly about a third vertical axis, wherein the first left end solar array assembly is pivotable between a storage position and a deployed position, wherein a second left end solar array assembly is pivotably connected to the second end of the left central solar array assembly about a fourth vertical axis, wherein the second left end solar array assembly is pivotable between a storage position and a deployed position, wherein the first left end solar array includes a frame having a solar portion secured thereto and the second left end solar array includes a frame having a solar portion secured thereto, wherein in the storage position, the frame of the first left end solar array and the frame of the second left end solar array face outwardly, wherein in the storage position, the left central solar array assembly is positioned between the first and second left end solar array assemblies and the chassis, and
a left arm side assembly that includes a left contact arm that is movable between a stowed position and a deployed position, wherein when the first and second left end solar array assemblies are in the storage position and the left contact arm is in the deployed position, a distal end of the left contact arm is positioned horizontally outboard of the outer surfaces of the first and second left end solar array assemblies, and wherein when the first and second left end solar array assemblies are in the storage position and the left contact arm is in the stowed position, the distal end of the left contact arm is positioned horizontally inboard of the outer surfaces of the first and second left end solar array assemblies,
at least a first jack assembly that includes a frame portion and a foot, wherein the jack assembly is hingedly connected to the chassis and is pivotable about a vertical jack axis between a stowed position and a deployed position, wherein the chassis includes a plurality of wheels attached thereto, wherein the foot is movable vertically between a stowed position and a deployed position,
wherein the top solar array assembly includes a frame and a solar portion, wherein the right central solar array assembly includes a frame and a solar portion, wherein the left central solar array assembly includes a frame and a solar portion, wherein the frame of the right central solar array assembly is pivotably connected to the frame of the top solar array assembly such that the right side solar array assembly can pivot about the first horizontal axis, and wherein the frame of the left central solar array assembly is pivotably connected to the frame of the top solar array assembly such that the left side solar array assembly can pivot about the second horizontal axis.

12. A method of deploying a solar array assembly, the method comprising the steps of:
pivoting a first right end solar array assembly about a first vertical axis from a stowed position to a deployed position,
pivoting a second right end solar array assembly about a second vertical axis from a stowed position to a deployed position,
pivoting a first left right end solar array assembly about a third vertical axis from a stowed position to a deployed position,
pivoting a second left end solar array assembly about a fourth vertical axis from a stowed position to a deployed position,
pivoting a right side solar array assembly from a stowed position to a deployed position about a first horizontal axis, and
pivoting a left side solar array assembly from a stowed position to a deployed position about a second horizontal axis.

13. The method of claim 12 wherein the right side solar array assembly includes a right central solar array assembly having first and second ends, wherein the first right end solar array assembly is pivotably connected to the first end of the right central solar array assembly, wherein a second right end solar array assembly is pivotably connected to the second end of the right central solar array assembly,
wherein the left side solar array assembly includes a left central solar array assembly having first and second ends, wherein the first left end solar array assembly is pivotably connected to the first end of the left central solar array assembly, wherein the second left end solar array assembly is pivotably connected to the second end of the left central solar array assembly.

14. The method of claim 13 wherein the solar array assembly includes a chassis that includes a top, bottom, left and right side surfaces, and front and rear surfaces, and a horizontally oriented top solar array assembly associated with the top of the chassis.

15. The method of claim 12 wherein the solar array assembly includes first and second batteries, wherein the method includes the steps of:
routing energy to the first battery,
switching to routing energy to the second battery,
removing the first battery while continuing to route energy to the second battery,
servicing the first battery,
reinstalling the first battery, and
switching to routing energy to the first battery.
